(19) United States
(12) Patent Application Publication
(10) Pub. No.: US 2016/0016403 A1
(43) Pub. Date: Jan. 21, 2016

(54) Droplet Actuator Devices and Methods

(71) Applicant: ADVANCED LIQUID LOGIC, INC., San Diego, CA (US)

(72) Inventor: Theodore Winger, Morrisville, NC (US)

(73) Assignee: ADVANCED LIQUID LOGIC, INC., San Diego, CA (US)

(21) Appl. No.: 14/870,433

(22) Filed: Sep. 30, 2015

Related U.S. Application Data
(63) Continuation of application No. 14/580,407, filed on Dec. 23, 2014.
Application No. 14/580,407 is a continuation of application No. 13/238,872, filed on Sep. 21, 2011, now Pat. No. 8,926,065.
Application No. 13/238,872 is a continuation-in-part of application No. PCT/US2010/040705, filed on Jul. 1, 2010.
(60) Provisional application No. 61/294,874, filed on Jan. 14, 2010.
(60) Provisional application No. 61/234,114, filed on Aug. 14, 2009.
(60) Provisional application No. 61/384,870, filed on Sep. 21, 2010.

(51) Int. Cl. B41J 2/14; B41J 2/16

(52) U.S. Cl. CPC B41J 2/14; B41J 2/1606; B41J 2002/14395; B41J 2002/14322

(57) ABSTRACT

A microfluidic device having a substrate with an electrically conductive element made using a conductive ink layer underlying a hydrophobic layer.

### 1 RELATED APPLICATIONS

This application is a continuation of and claims priority to U.S. patent application Ser. No. 14/580,407, entitled “Droplet Actuator Devices and Methods,” filed on Dec. 23, 2014, which is a continuation of and claims priority to U.S. patent application Ser. No. 13/238,872, entitled “Droplet Actuator Devices and Methods,” filed on Sep. 21, 2011 (now U.S. Pat. No. 8,926,065), the application of which is a continuation in part of and incorporates by reference International Patent Application Serial No. PCT/US2010/040705, entitled “Droplet Actuator Devices and Methods” International filing date of Jul. 1, 2010, the application of which is related to and claims priority to U.S. Provisional Patent Application Nos. 61/234,114, filed on Aug. 14, 2009, entitled “Droplet Actuator with Conductive Ink Ground”; 61/294,874, filed on Jan. 14, 2010, entitled “Droplet Actuator with Conductive Ink Ground”; the entire disclosures of which are incorporated herein by reference.

In addition, U.S. patent application Ser. No. 13/238,872 is related to and claims priority to U.S. Provisional Patent Application No. 61/384,870, filed on Sep. 21, 2010, entitled “Droplet Actuator with Conductive Ink Electrodes and/or Ground Planes,” the entire disclosure of which are incorporated herein by reference.

### 2 FIELD OF THE INVENTION

The invention generally relates to microfluidic systems. In particular, the invention is directed to droplet actuator devices for and methods of facilitating certain droplet actuated molecular techniques.

### 3 BACKGROUND OF THE INVENTION

Droplet actuators are used to conduct a wide variety of droplet operations. A droplet actuator typically includes one or more substrates configured to form a surface or gap for conducting droplet operations. The one or more substrates include electrodes for conducting droplet operations. The gap between the substrates is typically filled or coated with a filler fluid that is immiscible with the liquid that is to be subjected to droplet operations. Droplet operations are controlled by electrodes associated with the one or more substrates. Current designs of droplet actuators may have certain drawbacks, as follows. The substrates of a droplet actuator typically include electrodes and/or an electrical ground plane patterned thereon that are exposed to the droplet operations gap. The materials and/or processes for forming the electrodes and/or electrical ground planes may be costly. Consequently, there is a need for less costly materials and/or processes for forming the electrodes and/or electrical ground planes of droplet actuators.

### 4 BRIEF DESCRIPTION OF THE INVENTION

The invention provides a layered substrate. The layered substrate may include a base substrate; an electrically conductive element comprising a conductive ink layer on the base substrate; and a hydrophobic layer overlying at least a portion of the conductive ink layer on the base substrate. The layered substrate may include a droplet on the hydrophobic layer. The layered substrate may include an oil filler fluid on the hydrophobic layer. The electrically conductive element comprising a conductive ink layer on the base substrate may be patterned to form an electrode in an array of electrodes. The electrically conductive element comprising a conductive ink layer on the base substrate may include electrowetting electrodes.

The conductive ink may include a PEDOT ink. The conductive ink may include a PEDOT:PSS ink. The conductive ink may include a PEDOT ink and the hydrophobic layer may include a CYTOP coating. The conductive ink may include a PEDOT:PSS ink and the hydrophobic layer may include a CYTOP coating. The conductive ink may include a PEDOT ink and the hydrophobic layer may include a fluoropolymer coating. The conductive ink may include a PEDOT:PSS ink and the hydrophobic layer may include a fluoropolymer coating. The conductive ink may include a PEDOT ink and the hydrophobic layer may include an amorphous fluoropolymer coating. The conductive ink may include a PEDOT:PSS ink and the hydrophobic layer may include an amorphous fluoropolymer coating. The conductive ink layer may include a poly(3,4-ethylenedioxythiophene)-poly(styrenesulfonate) material. The conductive ink layer may include at least one of CLEVOS P Jet N, CLEVOS P Jet HC, CLEVOS P Jet N V2 and CLEVOS P Jet HC V2.

The invention provides a microfluidic device made using the layered substrate. The microfluidic device may include a second substrate separated from the layered substrate to provide a gap between the layered substrate and the second substrate. The second substrate may include: an electrically conductive element comprising a conductive ink layer on the second substrate facing the gap; and a hydrophobic layer overlying at least a portion of the conductive ink layer on the second substrate. The microfluidic device may include a droplet in the gap. The microfluidic device may include an oil filler fluid in the gap.

The base substrate may be formed using a material selected from the group consisting of silicon-based materials, glass, plastic and PCB. The base substrate may be formed of a material selected from the group consisting of glass, polycarbonate, COC, COP, PMMA, polystyrene and plastic.

The a dielectric layer may be disposed between the an electrically conductive element comprising a conductive ink layer on the base substrate and the hydrophobic layer overlying at least a portion of the conductive ink layer on the base substrate. The hydrophobic layer material may include a fluoropolymer.

The hydrophobic layer material may include an amorphous fluoropolymer. The hydrophobic layer material may include a polytetrafluoroethylene polymer. The base substrate is subject to a corona treatment prior to applying the conductive ink. The hydrophobic layer may include a CYTOP and the CYTOP is applied as a formulation in which the CYTOP is dissolved in a fluorinert solvent.

These and other embodiments will be apparent from the ensuing specification.

### 5 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), and other fluorinated monomers for plasma-enhanced chemical vapor deposition (PECVD). In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass) and PARYLENE™ N (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, and other fluorinated monomers for plasma-enhanced chemical vapor deposition (PECVD). Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1x-, 2x- 3x-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2x droplet is usefully controlled using 1 electrode and a 3x droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be a low-viscosity oil, such as silicone oil or hexadecane filler fluid. The filler fluid may fill the entire gap of the droplet actuator or may coat one or more surfaces of the droplet actuator. Filler fluids may be conductive or non-conductive. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 6 BRIEF DESCRIPTION OF THE DRAWINGS

FIG. 1 illustrates a cross-sectional view of an example of a portion of a droplet actuator that uses printed conductive inks to form electrodes and/or ground planes.

FIG. 2 illustrates a layered substrate having a base layer, an electrically conductive printed ink layer overlying the base layer, and a hydrophobic layer overlying at least a portion of the electrically conductive printed ink layer.

FIG. 3 illustrates a functional block diagram of an example of a microfluidics system including a droplet actuator.

FIGS. 4A and 4B illustrate side views of a portion of a droplet actuator that includes a replaceable cartridge.

FIGS. 5A and 5B illustrate side views of portions of a droplet actuator cartridge including a hinge region.

### 7 DETAILED DESCRIPTION OF THE INVENTION

The invention provides layered structures that are useful in a variety of contexts. For example, the layered structures are useful in a variety of microfluidic devices. Examples include microfluidic devices and sensors for microfluidic devices. In one embodiment, the layered structures are employed in microfluidic devices that are configured to employ the layered structures in order to conduct droplet operations. In another embodiment, the layered structures are employed in microfluidic devices that are configured to use the layered structures in order to sense one or more electrical properties of a droplet. In yet another embodiment, the layered structures are employed in microfluidic devices that are configured to use the layered structures to charge or discharge a droplet. Various other uses for the layered structures will be immediately apparent to one of skill in the art.

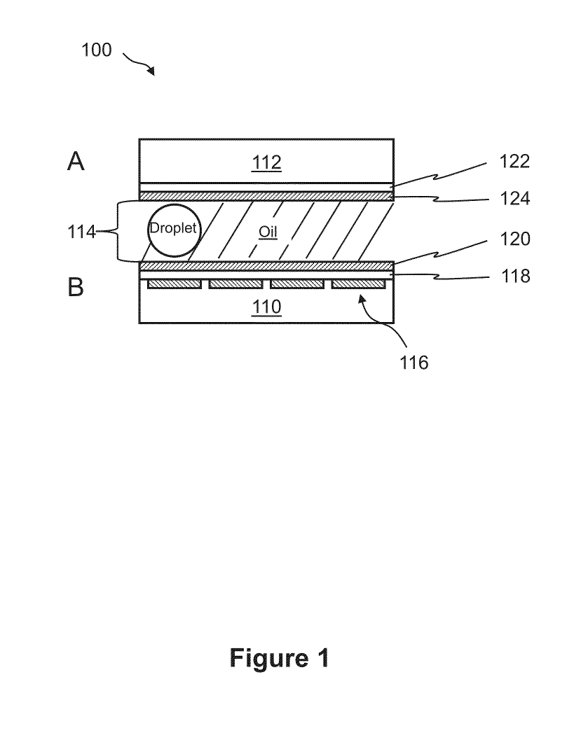

FIG. 1 illustrates an example of a microfluidic device employing the layered structures of the invention. The figure illustrates a top layered structure A and a bottom layered structure B. As illustrated, the two layered structures are arranged to form an electrolytic device. However, it will be appreciated that the layered structures may be used separately as components of electro-wetting microfluidic devices or other microfluidic devices. These layered structures are discussed in more detail below.

### 7.1 Top Substrate

Layered structure A shown in FIG. 1, is also referred to herein as top substrate A. Top substrate A includes a top substrate 112, conductive layer 122, and hydrophobic layer 124.

Top substrate 112 may be formed of any of a wide variety of materials. The materials may be flexible or substantially rigid, rigid, or combinations of the foregoing. Ideally, the material selected for substrate 112 is a dielectric material or a material that is coated with a dielectric material. Examples of suitable materials include printed circuit board (PCB), polymeric materials, plastics, glass, indium tin oxide (ITO)-coated glass, silicon and/or other semiconductor materials. Examples of suitable materials include: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper.

Plastics are preferred materials for fabrication of top substrate 112 of a droplet actuator due to their improved manufacturability and potentially lower costs. In one example, top substrate 112 may be formed of injection molded polycarbonate material that has liquid wells (e.g., sample and reagent wells) on one side and is flat on the other side. The top substrate 112 may also include a conductive layer 122. In one embodiment, the conductive layer 122 may be formed by vacuum deposition of a conductive material. In another embodiment, the conductive layer may be formed using conductive polymer films.

The top substrate 112 may also include a spacer (not shown) that separates the top substrate 112 from the bottom substrate 110. The spacer sets the gap 114 between a bottom substrate 110 and a top substrate 112 and determines the height of the droplet. Precision in the spacer thickness is required in order to ensure precision in droplet volume, which is necessary for accuracy in an assay. Islands of spacer material are typically required for control of gap height across large cartridges. In one embodiment, the spacer may be integrated within the injection molded polycarbonate material. In another embodiment, the spacer may be formed on the injection molded polycarbonate material by screen printing. Screen printing may be used to form a precision spacer that has small feature sizes and to form isolated spacer islands. A preferred spacer thickness is from about 0.010 inches to about 0.012 inches. In yet another embodiment, the spacer may be screen printed onto a conductive polymer film and laminated onto injection molded polycarbonate material.

### 7.2 Bottom Substrate

Layered structure B shown in FIG. 1, is also referred to herein as bottom substrate B. Bottom substrate B includes a bottom substrate 110, conductive elements 116, dielectric layer 118, and hydrophobic layer 124.

Bottom substrate 112 may be formed of any of a wide variety of materials. The materials may be flexible or substantially rigid, rigid, or combinations of the foregoing. Ideally, the material selected for bottom substrate 112 is a dielectric material or a material that is coated with a dielectric material. Examples of suitable materials include printed circuit board (PCB), polymeric materials, plastics, glass, indium tin oxide (ITO)-coated glass, silicon and/or other semiconductor materials. Examples of suitable materials include: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper.

### 7.3 Conductive Layer

As explained above, top substrate 112 includes conductive layer 122, and bottom substrate 110 includes conductive elements 116. Conductive layer 122 and/or conductive elements 116 may be formed using a conductive ink material. Conductive inks are sometimes referred to in the art as polymer thick films (PTF). Conductive inks typically include a polymer binder, conductive phase and the solvent phase. When combined, the resultant composition can be printed onto other materials. Thus, according to the invention, conductive layer 122 may be formed using a conductive ink which is printed onto substrate 112. Similarly, conductive element 116 may be formed using a conductive ink which is printed onto bottom substrate 110.

The conductive ink may be a transparent conductive ink. The conductive ink may be a substantially transparent conductive ink. The conductive ink may be selected to transmit electromagnetic radiation (EMR) in a predetermined range of wavelengths. Transmitted EMR may include EMR signal indicative of an assay result. The conductive ink may be selected to filter out EMR in a predetermined range of wavelengths. Filtered EMR may include EMR signal that interferes with measurement of an assay result. The conductive ink may be sufficiently transparent to transmit sufficient EMR to achieve a particular purpose, such as sensing sufficient EMR from an assay to make a quantitative and/or qualitative assessment of the results of the assay within parameters acceptable in the art given the type of assay being performed. Where the layered structure is used as a component of a microfluidic device, and the microfluidic device is used to conduct an assay which produces EMR as a signal indicative of quantity and/or quality of a target substance, the conductive ink may be selected to permit transmission of a sufficient amount of the desired signal in order to achieve the desired purpose of the assay, i.e. a qualitative and/or quantitative measurement through the conductive ink layer of EMR corresponding to target substance in the droplet.

The conductive ink may be sufficiently transparent to permit a sensor to sense from an assay droplet at least 50% of EMR within a target wavelength range which is directed towards the sensor. The conductive ink may be sufficiently transparent to permit a sensor to sense from an assay droplet at least 5% of EMR within a target wavelength range which is directed towards the sensor. The conductive ink may be sufficiently transparent to permit a sensor to sense from an assay droplet at least 90% of EMR within a target wavelength range which is directed towards the sensor. The conductive ink may be sufficiently transparent to permit a sensor to sense from an assay droplet at least 99% of EMR within a target wavelength range which is directed towards the sensor.

A particular microfluidic device may employ multiple conductive inks in different detection regions, such that in one region, one set of one or more signals may be transmitted through the conductive ink and therefore detected, while another set of one or more signals is blocked in that region. Two or more of such regions may be established that block and transmit selected sets of electromagnetic wavelengths. Moreover, where a substrate is used that produces background EMR, conductive inks may be selected on an opposite substrate to block the background energy while permitting transmission of the desired signal from the assay droplet. For example, conductive layer 122 may be selected to block background EMR from bottom substrate 110.

Conductive inks may be employed together with non-conductive inks in order to create a pattern of conductive and non-conductive regions with various optical properties established by the inks. For example, EMR transmitting (e.g., transparent, translucent) conductive inks may be used in a region where detection of EMR through the ink is desired, while EMR blocking (e.g., opaque, ink that filters certain bandwidths) conductive and/or non-conductive inks may be used in a region where detection is not desired in order to control or reduce background EMR. Moreover, conductive inks may be patterned in a manner which permits a droplet to remain in contact with the conductive ink while leaving an opening in the conductive ink for transmission of EMR.

Examples of suitable conductive inks include intrinsically conductive polymers. Examples include CLEVIOS™ PEDOT:PSS (Heraeus Group, Hanau, Germany) and BAYTRON® polymers (Bayer AG, Leverkusen, Germany. Examples of suitable inks in the CLEVIOS™ line include inks formulated for inkjet printing, such as P JET N, P JET HC, P JET N V2, and P JET HC V2. Other conductive inks are available from Orgacon, such as Orgacon PeDot 305+.

The conductive ink may be printed on the surface of top substrate 112 and/or bottom substrate 110. The ink may be patterned to create electrical features, such as electrodes, sensors, grounds, wires, etc. The pattern of the printing may bring the conductive ink into contact with other electrical conductors for controlling the electrical state of the conductive ink electrical elements.

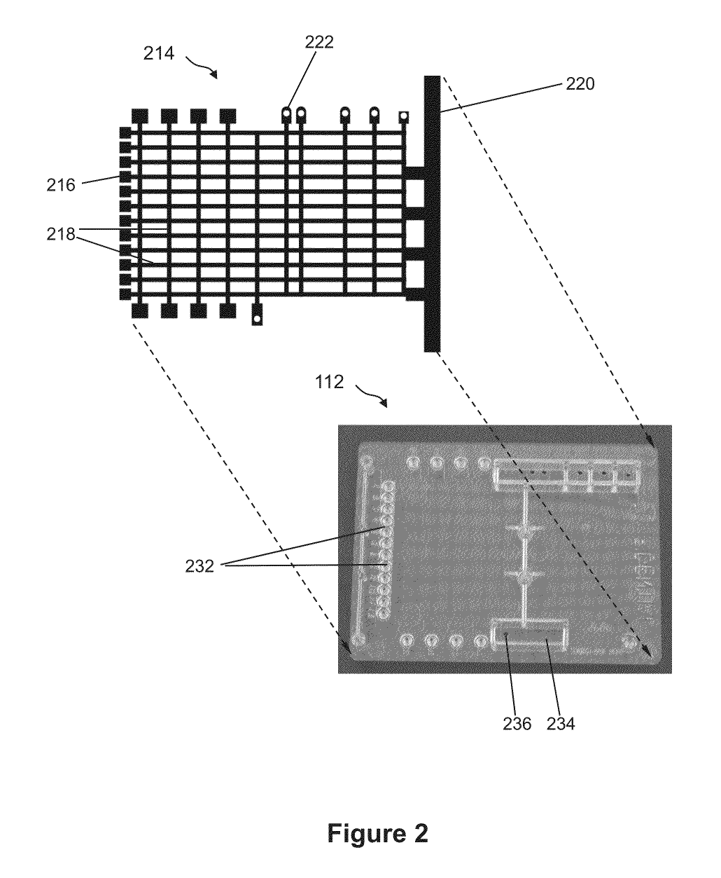

FIG. 2 illustrates top substrate 112. Top substrate 112 includes openings 232 for pipetting liquid through the top substrate 112 into a droplet operations gap 114. Openings 232 are positioned in proximity to reservoir electrodes situated on a bottom substrate (not shown) and arranged in association with other electrodes for conducting droplet dispensing operations. Top substrate 112 also includes reservoirs 234. Reservoirs 234 are molded into top substrate, and are formed as wells in which liquid can be stored. Reservoirs 234 include openings 236, which provide a fluid passage for flowing liquid from reservoirs 234 through top substrate 212 into a droplet operations gap 114. Openings 236 are arranged to flow liquid through top substrate 112 and into proximity with one or more droplet dispensing electrodes associated with a bottom substrate (not shown). Top substrate 112 includes a conductive ink reference electrode patterned on a bottom surface of top substrate 112 so that the conductive ink reference electrode faces the droplet operations gap 114. In this manner, droplets in the droplet operations gap 114 can be exposed to the reference electrode. The reference electrode pattern is designed to align with electrodes and electrode pathways on the bottom substrate. Thus, it can be seen from FIG. 2, that the reference electrode mirrors the bottom substrate electrodes, including portions 216 and 222 of the reference electrode 214 which correspond to droplet dispensing or reservoir electrodes on the bottom substrate, as well as portions 218 of the reference electrode 214, which correspond to droplet transport pathways established by electrodes on the bottom substrate. Reference electrode 214 also includes a connecting portion 220, which is used to connect reference electrode 214 to a source of reference potential, e.g. a ground electrode.

In one embodiment, the reference electrode pathways 218 overlie and have substantially the same width as electrode pathways on the bottom substrate. This arrangement provides for improved impedance detection of droplets in the droplet operation gap 114. Impedance across the droplet operations gap 114 from one of more electrodes on the bottom substrate to the reference electrode pathway 218 may be detected in order to determine various factors associated with the gap 114, such as whether droplet is situated between the bottom electrode and the reference electrode, to what extent the droplet is situated between the bottom electrode and the reference electrode, the contents of a droplet situated between the bottom of electrode and the reference electrode, whether oil has filled the gap 114 between the bottom electrode and the reference electrode, electrical properties of the droplet situated between the bottom electrode and the reference electrode, and electrical properties of the oil situated between the bottom electrode and the reference electrode.

In one embodiment, conductive ink is patterned on substrate 112 and/or substrate 110 to form an arrangement of electrode suitable for conducting one or more droplet operations. In one embodiment, the droplet operations are electrowetting-mediated droplet operations. In another embodiment, the droplet operations are dielectrophoresis-mediated droplet operations.

In one embodiment, the substrate is subject to a corona treatment prior to application of the conductive ink. For example, the corona treatment may be conducted using a high-frequency spot generator, such as the SpotTec™ spot generator (Tantec A/S, Lunderskov, Denmark). In another embodiment, the substrate is subject to plasma treatment prior to application of the conductive ink.

### 7.4 Dielectric Layer

In some embodiments, the layered structure will also include a dielectric layer. A dielectric layer is useful, for example, when the conductive ink is patterned to form electrodes for conducting droplet operations. For example, the droplet operations may be electrowetting-mediated droplet operations or dielectrophoresis-mediated droplet operations. FIG. 1, bottom substrate B includes dielectric layer 118 layered atop a patterned conductive layer 116, which may be a conductive ink layer. Various materials are suitable for use as the dielectric layer. Examples include: vapor deposited dielectric, such as PARYLENE™ C (especially on glass) and PARYLENE™ N (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; and polypropylene. Thus, in one embodiment, the invention includes a base layer, a conductive ink layer on the base layer, and a dielectric layer overlying the conductive ink layer and any exposed portions of the base layer. The base layer may be a substrate, such as described above with respect to FIG. 1 substrate 112 and substrate 110.

### 7.5 Hydrophobic Layer

As illustrated in FIG. 1, with respect to substrate A hydrophobic layer 124 may be deposited on conductive layer 122. Similarly, with respect to substrate B, hydrophobic layer 120 may be deposited atop dielectric layer 118. It will be appreciated that where the conductive ink layer and/or the dielectric layer is patterned, the hydrophobic layer may cover the conductive ink layer in some regions while covering the dielectric layer or even the base layer and other regions of the substrate. Focusing here on the conductive ink layer, the conductive ink layer may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the CYTOP family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), and other fluorinated monomers for plasma-enhanced chemical vapor deposition (PECVD). In some cases, the hydrophobic coating may have a thickness ranging from about 10 nm to about 1,000 nm.

### 7.6 Systems

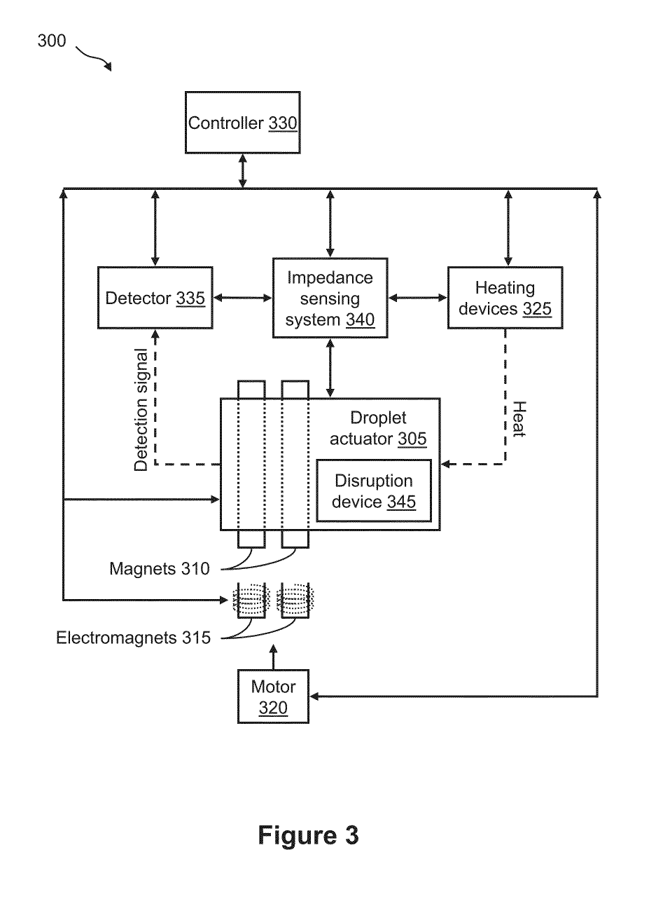

FIG. 3 illustrates a functional block diagram of an example of a microfluidics system 300 that includes a droplet actuator 305. Digital microfluidic technology conducts droplet operations on discrete droplets in a droplet actuator, such as droplet actuator 305, by electrical control of their surface tension (electrowetting). The droplets may be sandwiched between two substrates of droplet actuator 305, a bottom substrate and a top substrate separated by a droplet operations gap 114. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. The space around the droplets (i.e., the droplet operations gap 114 between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 305 may be designed to fit onto an instrument deck (not shown) of microfluidics system 300. The instrument deck may hold droplet actuator 305 and house other droplet actuator features, such as, but not limited to, one or more magnets and one or more heating devices. For example, the instrument deck may house one or more magnets 310, which may be permanent magnets. Optionally, the instrument deck may house one or more electromagnets 315. Magnets 310 and/or electromagnets 315 are positioned in relation to droplet actuator 305 for immobilization of magnetically responsive beads. Optionally, the positions of magnets 310 and/or electromagnets 315 may be controlled by a motor 320. Additionally, the instrument deck may house one or more heating devices 325 for controlling the temperature within, for example, certain reaction and/or washing zones of droplet actuator 305. In one example, heating devices 325 may be heater bars that are positioned in relation to droplet actuator 305 for providing thermal control thereof.

A controller 330 of microfluidics system 300 is electrically coupled to various hardware components of the invention, such as droplet actuator 305, electromagnets 315, motor 320, and heating devices 325, as well as to a detector 335, an impedance sensing system 340, and any other input and/or output devices (not shown). Controller 330 controls the overall operation of microfluidics system 300. Controller 330 may, for example, be a general purpose computer, special purpose computer, personal computer, or other programmable data processing apparatus. Controller 330 serves to provide processing capabilities, such as storing, interpreting, and/or executing software instructions, as well as controlling the overall operation of the system. Controller 330 may be configured and programmed to control data and/or power aspects of these devices. For example, in one aspect, with respect to droplet actuator 305, controller 330 controls droplet manipulation by activating/deactivating electrodes.

In one example, detector 335 may be an imaging system that is positioned in relation to droplet actuator 305. In one example, the imaging system may include one or more light-emitting diodes (LEDs) (i.e., an illumination source) and a digital image capture device, such as a charge-coupled device (CCD) camera.

Impedance sensing system 340 may be any circuitry for detecting impedance at a specific electrode of droplet actuator 305. In one example, impedance sensing system 340 may be an impedance spectrometer. Impedance sensing system 340 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 305 may include disruption device 345. Disruption device 345 may include any device that promotes disruption (lysis) of materials, such as tissues, cells and spores in a droplet actuator. Disruption device 345 may, for example, be a sonication mechanism, a heating mechanism, a mechanical shearing mechanism, a bead beating mechanism, physical features incorporated into the droplet actuator 3105, an electric field generating mechanism, a thermal cycling mechanism, and any combinations thereof. Disruption device 345 may be controlled by controller 330.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

7.7 Droplet Actuators with Disposable and Non-Disposable Components

The invention provides droplet actuator devices and methods for replacing one or more components of a droplet actuator. For example, the invention provides droplet actuator devices that may include the combination of both disposable components that may be readily replaced and non-disposable components that may be more expensive to manufacture. Ready replacement of one or more disposable components may also provide substantially unlimited re-use of a droplet actuator device or a portion of a droplet actuator device without concern for cross-contamination between applications. In one embodiment, moveable films may be used to readily replace substrate layers (e.g., dielectric and/or hydrophobic layers). In another embodiment, reversible attachment of a top substrate and a bottom substrate may be used to provide ready access to and replacement of one or more substrate layers. In yet another embodiment, a self-contained replaceable top cartridge may be used to provide a single-use, contaminant-free substrate. In yet another embodiment, selectively removable layered structures may be used to replace one or more dielectric and/or hydrophobic substrate layers. In yet another embodiment, a single-unit droplet actuator cartridge that is easily opened and closed may be used to provide a droplet actuator device wherein one or more substrate layers are readily removed and replaced.

### 7.7.1 Replaceable Top Cartridges

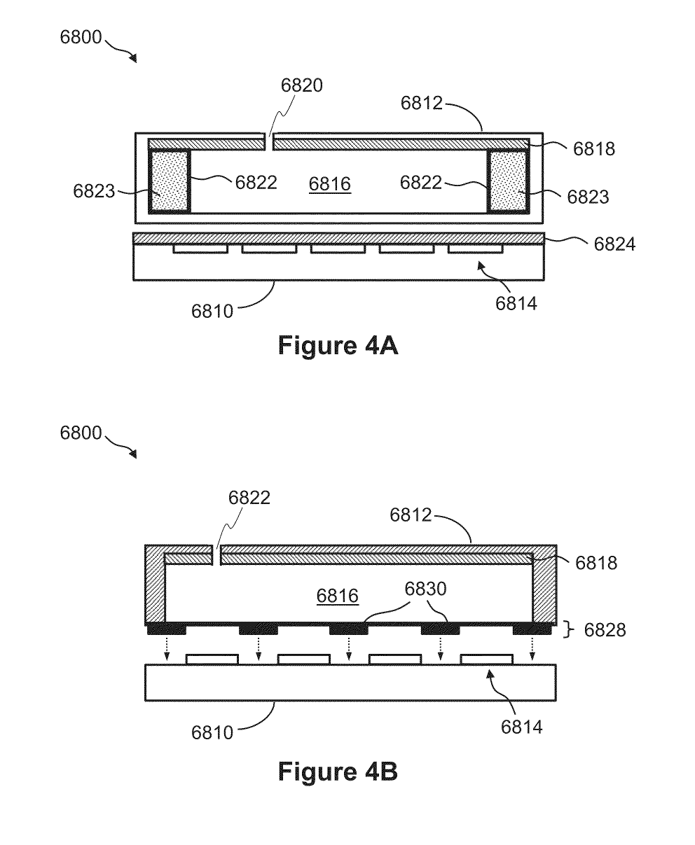

FIGS. 4A and 4B illustrate side views of a portion of a droplet actuator 6800 that includes a fixed bottom substrate and a removable top substrate, wherein the top substrate is a replaceable cartridge. The replaceable top cartridge of the invention is a self-contained cartridge, i.e., may include reagents, buffers, substrates and filler fluid required for a droplet actuator-based assay.

Droplet actuator 6800 may include a bottom substrate 6810, which may be fixed, and a replaceable top cartridge 6812. Bottom substrate 6810 may, for example, be formed of a PCB or a rigid material, such as a silicon-based material, glass, and/or any other suitable material. Bottom substrate 6810 may include a fixed array of droplet operations electrodes 6814 (e.g., electrowetting electrodes).

Top cartridge 6812 may be, for example, a plastic housing that is formed around an enclosed area 6816. Enclosed area 6816 may be of sufficient height for conducting droplet operations. In one embodiment, top cartridge 6812 may include a ground electrode 6818. In an alternative embodiment, ground electrode 6818 may be replaced with a hydrophobic layer (not shown) suitable for co-planar electrowetting operations. Top cartridge 6812 may include an opening 6820. Opening 6820 provides a fluid path from top cartridge 6812 into enclosed area 6816 in sufficient proximity of certain droplet operations electrodes 6814 on bottom substrate 6810. Opening 6820 may be used for loading one or more samples into top cartridge 6812. Positioning of top cartridge 6812 in sufficient proximity of certain droplet operations electrodes 6814 may, for example, be provided by alignment guides (not shown).

Referring to FIG. 4A, top cartridge 6812 may include one or more pouches 6822. Pouches 6822 may be used as fluid reservoirs for holding a volume of a certain fluid 6823. Pouches 6822 may be formed of a material that may be punctured for releasing fluid 6823 into enclosed area 6816. Fluid 6823 may be, for example, one or more different reagents required for droplet actuator-based assays. In one example one or more pouches 6822 may contain a filler fluid such as silicone oil. In this example, a piercing mechanism may be used for puncturing pouches 6822 and dispensing a filler fluid there from into enclosed area 6816 during alignment and loading of top cartridge 6812 onto bottom substrate 6810. In another example, one or more pouches 6822 may include reagents, buffers, and substrates required for performing a molecular assay. An interface material 6824 is disposed between top cartridge 6812 and bottom substrate 6810. Interface material 6824 may be, for example, a thin layer of certain liquid, certain grease, a certain soft material, or certain reversible glue. Interface material 6824 may also serve as the dielectric layer atop droplet operations electrodes 6814 of bottom substrate 6810. Referring to FIG. 4B, top cartridge 6812 may include a dielectric layer 6828 that interfaces with droplet operations electrodes 6814. Because top cartridge 6812 is a replaceable cartridge, dielectric layer 6828 is also replaceable. Dielectric layer 6828 may be patterned according to a desired topology that may, for example, correspond to a certain arrangement of droplet operations electrodes 6814 on bottom substrate 6810. For example, certain features 6830 may be patterned into dielectric layer 6828 for fitting between droplet operations electrodes 6814 on bottom substrate 6810 when assembled. In one example, a stamping process may be used to form features 6830 of dielectric layer 6828. More specifically, a stamp (not shown) may be provided that mimics the topology of bottom substrate 6810 that has droplet operations electrodes 6814 patterned thereon. Initially, dielectric layer 6828 is formed on top cartridge 6812 having a certain uniform thickness, and then the stamp may be brought into contact with dielectric layer 6828 of top cartridge 6812 under a certain amount of heat and/or pressure for a certain amount of time. In this way, a reverse impression of bottom substrate 6810 that has droplet operations electrodes 6814 patterned thereon is formed in dielectric layer 6828 of top cartridge 6812, thereby forming, for example, features 6830. The reverse impression of droplet operations electrodes 6814 of bottom substrate 6810 that is patterned into dielectric layer 6828 of top cartridges 6812 provides a tight coupling between bottom substrate 6810 and top cartridge 6812 when assembled.

### 7.7.2 Single-Unit Droplet Actuator Cartridge

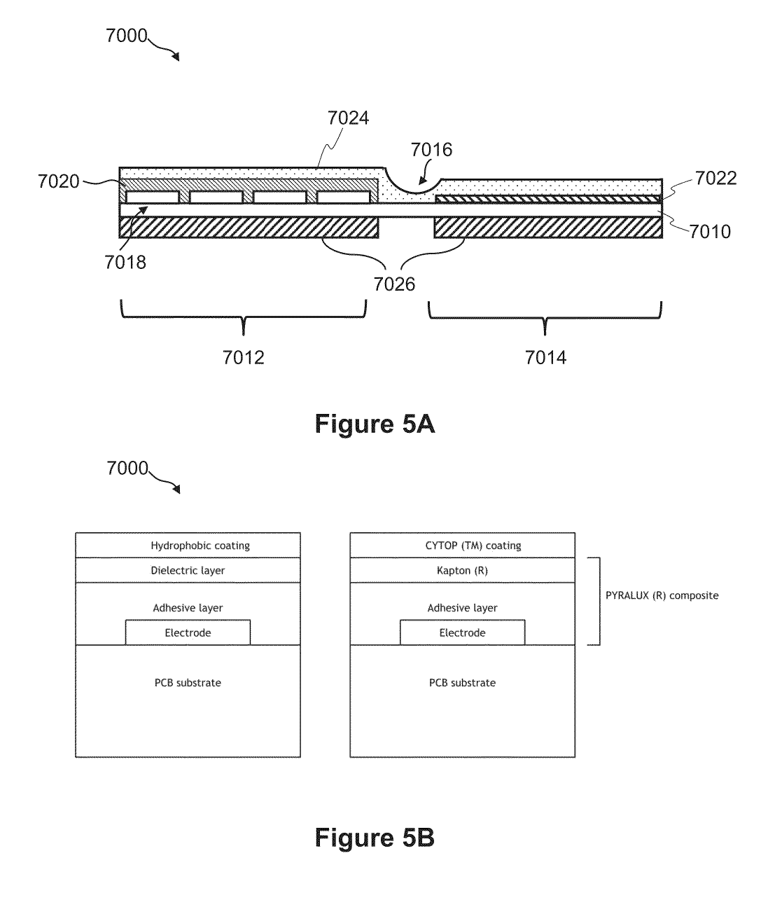

FIGS. 5A and 5B illustrate side views of portions of a droplet actuator cartridge 7000. Droplet actuator cartridge 7000 is an example of a droplet actuator wherein a rigid-flex process may be used to form a single unit droplet actuator cartridge.

Cartridge 7000 may include a flexible substrate 7010. Flexible substrate 7010 may be selectively processed (e.g., rigid-flex processing) to provide certain regions for conducting droplet operations. For example, flexible substrate 7010 may include a bottom substrate region 7012 and a top substrate region 7014. Bottom substrate region 7012 and top substrate region 7014 may be separated by a hinge region 7016. Hinge region 7016 provides a mechanism to fold top substrate region 7014 into proximity of bottom substrate region 7012 (i.e., to close cartridge 7000). In the closed position, cartridge 7000 is ready for operation. Hinge region 7016 also provides a mechanism to readily open cartridge 7000. Cartridge 7000 may, for example, be readily opened at hinge region 7016 for removing and replacing one or more substrate layers.

Bottom substrate region 7012 may include a path or array of droplet operations electrodes 7018 (e.g., electrowetting electrodes). A dielectric layer 7020 may be selectively disposed atop droplet operations electrodes 7018 in bottom substrate region 7012. In one embodiment and referring to FIG. 5B, dielectric layer 7020 may be an adhesive backed polyimide, such as a Pyralux LF coverlay composite (DuPont). In one example, Pyralux LF7013 may be used. Pyralux LF7013 includes an approximately 25 micrometer thick Dupont KAPTON® polyimide film and an approximately 25 micrometer thick acrylic adhesive. In another example, a Pyralux coverlay composite that includes a polyimide film and adhesive layer of a different thickness may be used.

Top substrate region 7014 may include a ground electrode 7022. Ground electrode 7022 may, for example, be formed of copper or another suitable material. A hydrophobic layer 7024 may be disposed as a final layer atop bottom substrate region 7012, top substrate region 7014, and hinge region 7016. In one embodiment and again referring to FIG. 5B, hydrophobic layer 7024 may be a Cytop™ coating. Hydrophobic layer 7024 may, for example, be approximately 700 nm to several microns in thickness.

An optional rigid layer 7026 may be disposed on the surface of flexible substrate 7010 that is opposite droplet operations electrodes 7016 and ground electrode 7022 and excluding hinge region 7014.

### 8 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

1-27. (canceled)

28. A microfluidic device comprising a layered substrate comprising:
a. a base substrate made from paper;
b. an array of electrodes on the base substrate; and
c. a dielectric layer atop the array of electrodes.

29. The microfluidic device of claim 28 wherein an electrode in the array of electrodes is formed by an electrically conductive element comprising a conductive ink layer on the base substrate.

30. The microfluidic device of claim 29 wherein the electrically conductive element comprising a conductive ink layer on the base substrate comprises electrowetting electrodes.

31. The microfluidic device of claim 30 wherein the dielectric layer is disposed between the electrically conductive element comprising a conductive ink layer on the base substrate and a hydrophobic layer overlying at least a portion of the conductive ink layer on the base substrate.

32. The microfluidic device of claim 31 wherein the hydrophobic layer material comprises a fluoropolymer.

33. The microfluidic device of claim 31 wherein the hydrophobic layer material comprises an amorphous fluoropolymer.

34. The microfluidic device of claim 31 wherein the hydrophobic layer material comprises a polytetrafluoroethylene polymer.

35. The microfluidic device of claim 31 wherein the conductive ink layer comprises a poly(3,4-ethylenedioxythiophene)-poly(styrenesulfonate) material.

36. The microfluidic device of claim 31 wherein the conductive ink layer comprises at least one of CLEVOS P Jet N, CLEVOS P Jet HC, CLEVOS P Jet N V2 and CLEVOS P Jet HC V2.

37. The microfluidic device of claim 31 wherein the base substrate is subject to a corona treatment prior to applying the conductive ink.

38. The microfluidic device of claim 31 wherein the conductive ink comprises a CYTOP and the CYTOP is applied as a formulation in which the CYTOP is dissolved in a fluorinert solvent.

39. The microfluidic device of claim 28 further comprising a second substrate separated from the layered substrate to provide a gap between the layered substrate and the second substrate.

40. The microfluidic device of claim 39 further comprising a droplet in the gap.

41. The microfluidic device of claim 39 further comprising an oil filler fluid in the gap.

42. The microfluidic device of claim 39 wherein the second substrate comprises:
a. an electrically conductive element comprising a conductive ink layer on the second substrate facing the gap; and
b. a hydrophobic layer overlying at least a portion of the conductive ink layer on the second substrate.

43. The microfluidic device of claim 42 wherein the hydrophobic layer material on the second substrate comprises a fluoropolymer.

44. The microfluidic device of claim 42 wherein the hydrophobic layer material on the second substrate comprises an amorphous fluoropolymer.

45. The microfluidic device of claim 42 wherein the hydrophobic layer material on the second substrate comprises a polytetrafluoroethylene polymer.

46. The microfluidic device of claim 42 wherein the conductive ink layer on the second substrate comprises a poly(3,4-ethylenedioxythiophene)-poly(styrenesulfonate) material.

47. The microfluidic device of claim 42 wherein the conductive ink layer on the second substrate comprises at least one of CLEVOS P Jet N, CLEVOS P Jet HC, CLEVOS P Jet N V2 and CLEVOS P Jet HC V2.

48. The microfluidic device of claim 42 wherein the conductive ink on the second substrate comprises a CYTOP and the CYTOP is applied as a formulation in which the CYTOP is dissolved in a fluorinert solvent.

49. A microfluidic device comprising: a layered substrate comprising: (a) a base substrate made from paper; (b) an electrically conductive element comprising a conductive ink layer on the base substrate; and (c) a hydrophobic layer overlying at least a portion of the conductive ink layer in the base substrate; and further comprising a second substrate separated from the layered substrate to provide a gap between the layered substrate and the second substrate.

50. A layered substrate comprising: (a) a base substrate made from paper; (b) an electrically conductive element comprising the conductive ink layer on the base substrate; and (c) a hydrophobic layer overlying at least a portion of the conductive ink layer in the base substrate; and wherein the electrically conductive element comprising a conductive ink layer on the base substrate comprises an electrode in an array of electrodes.

51. A layered substrate comprising: (a) a base substrate made from paper; (b) an electrically conductive element comprising the conductive ink layer on the base substrate; and (c) a hydrophobic layer overlying at least a portion of the conductive ink layer in the base substrate; and wherein the electrically conductive element comprising a conductive ink layer on the base substrate comprises electrowetting electrodes.

52. A layered substrate comprising: (a) a base substrate made from paper; (b) an electrically conductive element comprising the conductive ink layer on the base substrate; and (c) a hydrophobic layer overlying at least a portion of the conductive ink layer on the base substrate; and further comprising a dielectric layer disposed between the an electrically conductive element comprising a conductive ink layer on the base substrate and the hydrophobic layer overlying at least a portion of the conductive ink layer on the base substrate.

53. A layered substrate comprising: (a) a base substrate made from paper; (b) an electrically conductive element comprising a conductive ink layer on the base substrate; and (c) a hydrophobic layer overlying at least a portion of the conductive ink layer on the base substrate; wherein the base substrate is subject to a corona treatment prior to applying the conductive ink.

54. A layered substrate comprising: (a) a base substrate made from paper (b) an electrically conductive element comprising a conductive ink layer on the base substrate; and (c) a hydrophobic layer overlying at least a portion of the conductive ink layer on the base substrate; wherein the conductive ink comprises a CYTOP and the CYTOP is applied as a formulation in which the CYTOP is dissolved in a fluorinert solvent.

55. A microfluidic device comprising a layered substrate comprising:
a. a base substrate made from paper;
b. at least one electrode on the base substrate;
c. a dielectric layer atop the at least one electrode;
d. a hydrophobic layer on the dielectric layer;
e. a droplet comprising water in contact with the hydrophobic layer; and
f. a voltage source for activating the electrode to manipulate the droplet.

56. The microfluidic device of claim 55 wherein the at least one electrode is in an array of electrodes formed by an electrically conductive element comprising a conductive ink layer on the base substrate.

57. The microfluidic device of claim 56 wherein the electrically conductive element comprising a conductive ink layer on the base substrate comprises electrowetting electrodes.

58. The microfluidic device of claim 57 wherein the dielectric layer is disposed between the electrically conductive element comprising a conductive ink layer on the base substrate and a hydrophobic layer overlying at least a portion of the conductive ink layer on the base substrate.

59. The microfluidic device of claim 58 wherein the hydrophobic layer material comprises a fluoropolymer.

60. The microfluidic device of claim 58 wherein the hydrophobic layer material comprises an amorphous fluoropolymer.

61. The microfluidic device of claim 58 wherein the hydrophobic layer material comprises a polytetrafluoroethylene polymer.

62. The microfluidic device of claim 58, wherein the hydrophobic layer material comprises TEFLON® or FLUOROPEL®.

63. The microfluidic device of claim 58 wherein the conductive ink layer comprises a poly(3,4-ethylenedioxythiophene)-poly(styrenesulfonate) material.

64. The microfluidic device of claim 58 wherein the conductive ink layer comprises at least one of CLEVOS P Jet N, CLEVOS P Jet HC, CLEVOS P Jet N V2 and CLEVOS P Jet HC V2.

65. The microfluidic device of claim 58 wherein the base substrate is subject to a corona treatment prior to applying the conductive ink.

66. The microfluidic device of claim 55 wherein the conductive ink comprises a CYTOP and the CYTOP is applied as a formulation in which the CYTOP is dissolved in a fluorinert solvent.

67. The microfluidic device of claim 55 further comprising a second substrate separated from the layered substrate to provide a gap between the layered substrate and the second substrate.

68. The microfluidic device of claim 67 wherein the droplet is in the gap.

69. The microfluidic device of claim 67 further comprising an oil filler fluid in the gap.

70. The microfluidic device of claim 69 wherein the second substrate comprises:
a. an electrically conductive element comprising a conductive ink layer on the second substrate facing the gap; and
b. a hydrophobic layer overlying at least a portion of the conductive ink layer on the second substrate.

71. The microfluidic device of claim 70 wherein the hydrophobic layer material on the second substrate comprises a fluoropolymer.

72. The microfluidic device of claim 70 wherein the hydrophobic layer material on the second substrate comprises an amorphous fluoropolymer.

73. The microfluidic device of claim 70 wherein the hydrophobic layer material on the second substrate comprises a polytetrafluoroethylene polymer.

74. The microfluidic device of claim 70 wherein the conductive ink layer on the second substrate comprises a poly(3,4-ethylenedioxythiophene)-poly(styrenesulfonate) material.

75. The microfluidic device of claim 70 wherein the conductive ink layer on the second substrate comprises at least one of CLEVOS P Jet N, CLEVOS P Jet HC, CLEVOS P Jet N V2 and CLEVOS P Jet HC V2.

76. The microfluidic device of claim 70 wherein the conductive ink on the second substrate comprises a CYTOP and the CYTOP is applied as a formulation in which the CYTOP is dissolved in a fluorinert solvent

77. The microfluidic device of claim 55, wherein the at least one electrode is constructed from copper or indium tin oxide.

78. The microfluidic device of claim 55, wherein the dielectric layer is constructed from PARYLENE™ or silicon.

79. The microfluidic device of claim 55, wherein the voltage source provides an alternating current or a direct current.

80. The microfluidic device of claim 55, wherein the at least one electrode is grounded.

81. The microfluidic device of claim 55, wherein the water comprises deionized water.
